(19) United States
(12) Patent Application Publication
(10) Pub. No.: US 2018/0041053 A1
(43) Pub. Date: Feb. 8, 2018

(54) Device for Exchanging and Charging Batteries on Remote Controlled Hobby Vehicles

(71) Applicant: Peter D. Capizzo, Madison, AL (US)

(72) Inventor: Peter D. Capizzo, Madison, AL (US)

(21) Appl. No.: 15/230,451

(22) Filed: Aug. 7, 2016

(51) Int. Cl. H02J 7/00; A63H 29/22; A63H 30/04

(52) U.S. Cl. CPC H02J 7/0027; H02J 7/0044; A63H 30/04; A63H 29/22

(57) ABSTRACT

An Automatic Exchanging and Charging Station (AECS) for replenishing electrical energy sources onboard electric powered RC vehicles is disclosed herein. In one embodiment, the automatic exchanging and charging station includes a rack, replaceable batteries, a service module, and an electronic computer control system. The replaceable batteries are stocked on the rack and substantially charged as energy sources within RC vehicles. The service module is mounted on the rack, and the electronic computer control system is connected in electrical communication with the service module. In this configuration, the service module is controllably operable to receive a depleted replaceable battery from a RC vehicle and also selectively deliver one of the charged replaceable batteries onboard the RC vehicle. In another embodiment, the service station facility may also stock replaceable energy cells such as capacitors for selective delivery onboard RC vehicles.

### FIELD OF THE INVENTION

The present invention generally relates to radio controlled hobby vehicles that are Remotely Controlled (RC) and have mobility. More particularly, the present invention relates to the hobby industry RC models cars and trucks.

### BACKGROUND OF THE INVENTION

In applications where RC hobby vehicles need reenergizing periodically, the normal procedure is to discontinue operations and either recharge the batteries onboard or manually replace the batteries. Onboard recharging means the vehicle is put out of operation until the batteries are recharged. Recharging batteries usually takes 20 minutes or more for RC hobby cars. The down time for recharging battery powered RC hobby vehicles is usually unacceptable and another vehicle is put into use if available. Alternatively, exchanging the depleted batteries with charged ones eliminates the problem of down time or having multiple vehicles in reserve. However, presently virtually all battery exchanging is done manually, which can be quite time consuming itself.

This invention replaces the manual operations of exchanging and recharging batteries on remote controlled vehicles with an Automatic Exchanging and Charging Station, (AECS) for short, which may include a battery charging system for automatically recharging batteries removed for exchange. The automatic exchanging and charging operations is facilitated by the fact that the remote controlled (RC) vehicles are generally mobile, and can be directed to and made to interface with the AECS. Remote controlled can mean any number of ways of communicating control signals to the RC vehicle, including radio frequencies, light waves, infrared waves, microwave waves, etc., or electrically by wire.

The various battery types' onboard RC vehicles may particularly include batteries of the following type: nickel-cadmium type batteries, nickel/metal-hydride type batteries, silver-zinc type batteries, lead-acid type batteries, and lithium-ion type batteries. In particular, when the battery of a RC vehicle becomes discharged during use, the vehicle's operator must then discontinue operations for a significant period of time while the vehicle's battery is recharged. To remedy such a problem, an operator of a RC vehicle having a discharged battery can either switch vehicles, obtaining a replacement vehicle with a fully charged battery, or alternatively the operator may manually exchange the battery on the RC vehicle with a fully charged one in reserve. Such discontinuity in use of RC vehicles, however, may not be generally practical, or fun, for persons are organizations needing or wanting long-distance and/or frequent and repetitive vehicle use, like racing for example.

Therefore, in view of the above, there is a present need in the art for an Automatic Exchanging and Charging Station (AECS) that is both equipped and able to exchange and recharge various battery types onboard different types of RC vehicles in short periods of time.

### SUMMARY OF THE INVENTION

The present invention provides an Automatic Exchanging and Charging Station (AECS) for exchanging and charging various battery types of RC vehicles. In one embodiment, the automatic exchanging and charging station may include a rack, a plurality of replaceable batteries, a service module, and an electronic computer control system. The replaceable batteries are stocked on the rack and substantially charged. The service module is mounted on the rack, and the electronic computer control system is connected in electrical communication with the service module. In this configuration, the service module is controllably operable to receive a depleted replaceable battery from a RC vehicle and also selectively deliver one of the substantially charged batteries to the RC vehicle. The automatic exchanging and charging station may optionally further include a battery charging system for recharging the received depleted vehicle batteries while stocked/stored on the rack.

Furthermore, it is believed that various alternative embodiments of the present invention will become apparent to those skilled in the art when the detailed description of the best mode(s) contemplated for practicing the present invention, as set forth hereinbelow, is reviewed in conjunction with the appended claims and the accompanying drawing figures.

### BRIEF DESCRIPTION OF THE DRAWINGS

The present invention is described hereinbelow, by way of example, with reference to the following drawing figures.

FIG. 1 illustrates a side view of one practicable embodiment of an AECS for exchanging and charging batteries onboard RC vehicles.

FIG. 2 illustrates a perspective view of the automatic exchanging and charging station depicted in FIG. 1. In this view, the AECS is partially cut away and shown to include a rack and a plurality of replaceable batteries stocked on the rack by means of a circulating conveyor system.

FIG. 3 illustrates a perspective view highlighting the circulating conveyor system depicted in FIG. 2.

FIG. 4 illustrates a perspective view of a transfer manifold of the circulating conveyor system depicted in FIG. 3.

FIG. 5 illustrates a partial sectional view of a holding clamp assembly of the circulating conveyor system depicted in FIG. 3.

FIG. 6 illustrates a perspective view of another practicable embodiment of an AECS station facility. In this view, the AECS is partially cut away and shown to include a rack and a plurality of replaceable batteries stocked on the rack by means of a robotic arm engaged on a rail system.

FIG. 7 illustrates a partial sectional view of a robotic service module mounted on the rack of the service station facility depicted in FIG. 6. In this view, the robotic service module is engaged underneath the battery of a vehicle being serviced.

### UST OF PARTS AND FEATURES

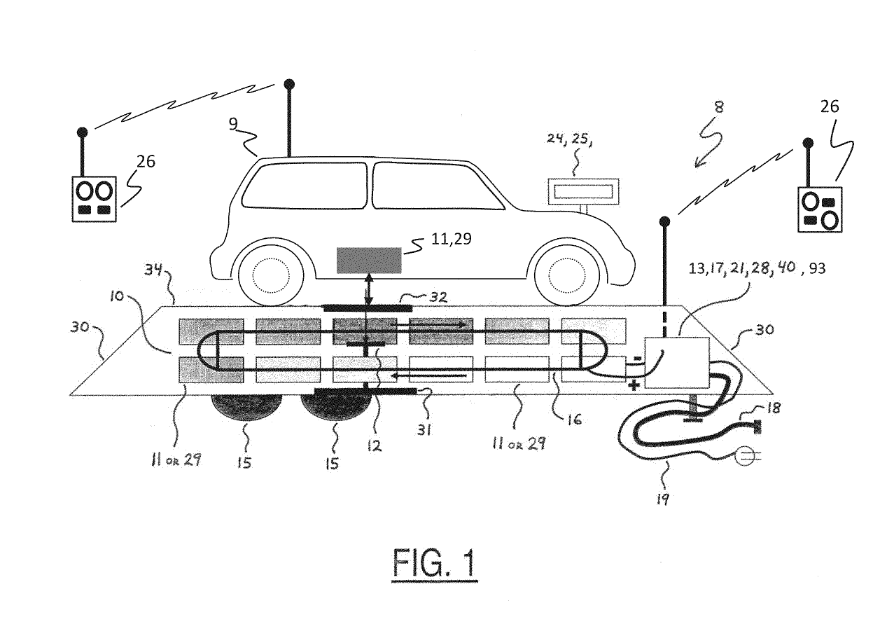

To facilitate an understanding of the present invention, a list of parts and features highlighted with alphanumeric designations in FIGS. 1 through 7 is set forth hereinbelow.
8 AECS (first embodiment as a towable trailer)
9 RC vehicle
10 rack or framework
11 batteries
12 robotic service module
13 electronic computer control system
14 hitch or tow bar
15 wheel(s) (mounted at the bottom of the rack)
16 conveyor system
17 cooling system (for cooling batteries during charging)
18 hose (for receiving water, for example)
19 cable (for receiving electricity)
20 AECS (second embodiment as in-ground facility)
21 electric charging system (for recharging batteries)
22 position sensor(s) (for alignment of robotic service module to RC vehicle)
23 identification scanner or transceiver
24 control panel
25 display monitor
26 Remote controller (for RC vehicles)
27 storage tanks(s) (which may store, for example, cooling water)
28 fluid pumping system (for pumping, for example, cooling water)
29 energy cells (capacitors, for example)
30 foldable ramp(s) (for RC vehicles to egress and depart)
31 hydraulic lift system (for lifting and aligning the robotic service module)
32 service hole (in service platform)
33 (placeholder number)
34 service platform (for RC vehicle)
35 stabilizer(s)
36 rack-and-pinion mechanism (for adjusting the robotic service module)
37 permanent vehicle guide rail(s) (for RC vehicles)
38 Optional guide rail(s)
39 signaling device (for giving RC driving instructions such as go, slow, stop)
40 heating and cooling system
41 transfer manifold (of conveyor system)
42 quick disconnect (breaks before rotation)
43 quick disconnect (makes before rotation)
44 dual quick disconnect manifold
45 slip ring
46 hose wheel (of conveyor system)
47 liquid supply line (from cooling system for example)
48 liquid umbilical hose and/or electric cable
49 clamp(s)
50 transfer line(s) (liquid cooling hoses and/or electric recharging cables)
51 holding damp assembly (for conveyor system)
52 electric power connector
53 electric power input connector
54 liquid inlet port (passing, for example, water)
55 retention pin(s)
56 holding clamp(s)
57 quick disconnect(s)
58 electromagnetic actuator (for example, a quick disconnect solenoid)
59 electromagnetic driver (for example, a clamping solenoid)
60 power and status signal cable (for heating and cooling system)
61 bearing(s)
62 roller bearing(s)
63 roller assembly
64 railing (of conveyor system)
65 pull chain
66 sprocket wheel (for engaging pull chain)
67 front end axle of conveyor system (driven by an electric step motor for example)
68 cooling vent(s)
69 hook-up (for receiving water)
70 hook-up (for receiving electricity)
71 controllable robotic arm (for moving batteries for example)
72 positionable carriage (for supporting robotic arm)
73 electric motor (for positioning robotic arm carriage on rail system)
74 rail system (for moving robotic arm about the rack)
75 in-ground enclosure (made of, for example, fiberglass)
76 bay area (for recharging batteries for example)
77 compartment
78 power source (for electric heater)
79 utility trough (for umbilical hoses, cooling hoses, and electric charging cables)
80 liquidizer and refrigeration system (chiller)
81 rail system (for moving and positioning the robotic service module)
82 ground level
83 vehicle retention mechanism(s)
84 alignment pin(s)
85 electric torque motor(s)
86 electric motor
87 jackscrew
88 electric motor (for adjusting the robotic service module)
89 motor mount(s)
90 electric power input connector
91 liquid inlet port (passing, for example, water)
92 hose coupler
93 Receiver and Transmitter

### DETAILED DESCRIPTION OF THE INVENTION

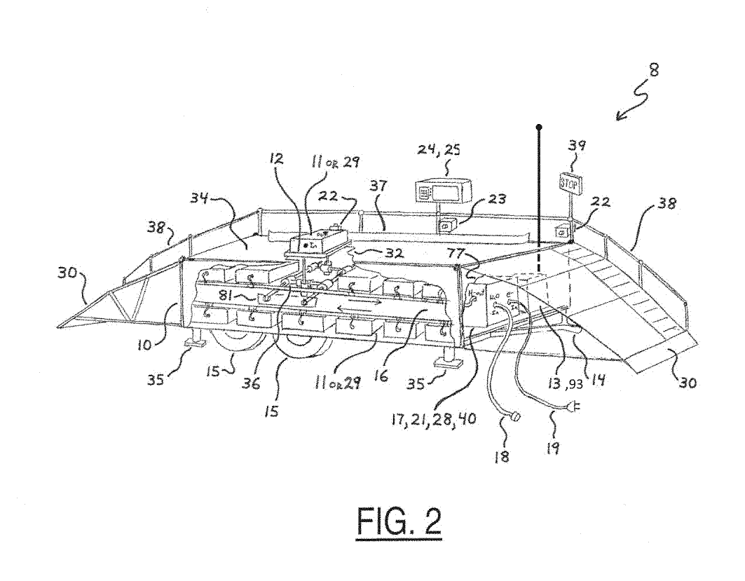

FIGS. 1 and 2 respectively illustrate side and perspective views of one practicable embodiment of an Automatic Exchanging and Charging Station (AECS) 8 pursuant to the present invention. In general, the AECS 8 is adapted for replenishing various battery types onboard different types of RC vehicles.

As shown in FIGS. 1 and 2, the AECS facility 8 includes a rack 10, a plurality of batteries 11, a robotic service module 12, and an electronic computer control system 13. The replaceable batteries 11 are stocked on the rack 10 and substantially charged utile as motivational energy sources within battery-operated RC vehicles. The robotic service module 12 is adjustably mounted on the rack 10 via a hydraulic lift system 31, a rack-and-pinion mechanism 36, and a rail system 81. The electronic computer control system 13 is connected in electrical communication with the robotic service module 12 and its adjusting systems and mechanisms as well. In this configuration, the robotic service module 12 is controllably operable to remove a depleted battery from a battery-operated RC vehicle 9 and also selectively install one of the recharged batteries 11 onboard the battery-operated RC vehicle 9. As used herein, the term “robotic service module” may include any electrically, mechanically, hydraulically, and/or pneumatically assisted arms or lever mechanisms.

As further shown in FIGS. 1 and 2, the AECS 8 also includes a closed-loop conveyor system 16 on which the batteries 11 are releasably held. The conveyor system 16 is mounted on the rack 10 and connected in electrical communication with the electronic computer control system 13. In this configuration, the conveyor system 16 is controllably operable to circulate the batteries 11 about the service station facility 8 so that the robotic service module 12 has selective access to each of the batteries 11.

As best shown in FIG. 2, the AECS 8 further includes a cooling system 17 for cooling the batteries. The cooling system 17 itself has both a hose 18 and a cable 19 for thereby receiving water and electricity from public utilities. The cooling system 17 is connected in electrical communication with the electronic computer control system 13 and also controllably connectable in fluidal communication with any of the batteries 11 on the conveyer system 16. In this configuration, the cooling system 17 is controllably operable to receive both water and electricity to thereby produce chilled coolant so as to substantially cool batteries 11 on the conveyor system 16 that are designated for exchange. Furthermore, it is to be understood that the cooling system 17, or any other cooling system in general, may alternatively be situated in a second facility that is located near to the service station facility 8 and connected thereto via one or more fluid and/or electrical supply lines. Such an alternative arrangement may in some circumstances be desirable if a cooling system is deemed to be too large to include within the service station facility 8. In this way, the service station facility 8 is still able to maintain its portability.

In addition to including the batteries 11, the AECS 8 also includes a plurality of replaceable alternative energy cells 29 stocked on the rack 10. In general, the energy cells 29 are all substantially charged and are sufficient and utile as motivational energy sources within RC vehicles. As depicted in FIGS. 1 and 2, the replaceable energy cells 29 are releasably held on the conveyor system 16 along with the batteries 11. In this configuration, the conveyor system 16 is controllably operable to circulate the replaceable energy cells 29 about the service station facility 8 so that the robotic service module 12 has selective access to each of the energy cells 29. In this way, the robotic service module 12 is controllably operable to remove a discharged replaceable energy cell from a RC vehicle and also selectively install one of the charged replaceable energy cell 29 onboard the RC vehicle.

In general, the plurality of replaceable batteries 11 stocked on the rack 10 may include many different types of batteries that are utile within battery-operated RC vehicles. Though other types of batteries are possible, some of these batteries 11 may particularly include, for example, a lead-acid type battery, a lithium-ion type battery, a nickel-cadmium type battery, a nickellmetal-hydride type battery, or a silver-zinc type battery. The polarity of replaceable energy cells 29 stocked on the rack 10 may include many different types of energy cells that are utile within RC vehicles. Though other types of energy cells are possible, some of these energy cells 29 may particularly include, for example, a capacitor,

As shown in FIGS. 1 and 2, the AECS 8 further includes an electric charging system 21 for recharging any batteries 11 or energy cells 29 on the conveyor system 16 that are discharged. The electric charging system 21 is connected in electrical communication with the cable 19 for thereby receiving electricity from a public utility, or from a local power generating facility such as a solar powered generator mounted on a trailer. In addition, the electric charging system 21 is connected in electrical communication with the electronic computer control system 13 and also controllably connectable in electrical communication with any of the replaceable batteries 11 or energy cells 29 on the conveyor system 16. In this configuration, the electric charging system 21 is controllably operable to substantially charge any of the replaceable batteries 11 or energy cells 29 on the conveyor system 16 that are designated for recharging.

As best shown in FIG. 2, the AECS 8 further includes a plurality of wheels 15, a hitch 14, and one or more stabilizers 35. The hitch 14 is mounted on one end of the rack 10, and the wheels 15 are rotatably mounted at the bottom of the rack 10. In this configuration, both the hitch 14 and the wheels 15 facilitate towing of the AECS 8 by, for example, a RC vehicle, where the towing vehicle can optionally be serviceable by the AECS itself. Whenever the AECS 8 is unhitched, each stabilizer 35 helps balance and stabilize the AECS 8 so that an RC vehicle 9 can be safely driven up one of the ramps 30 and onto the stations service platform 34 for service.

As further shown in FIG. 2, the AECS 8 also includes one or more position sensors 22 and an electronic signaling device 39. The position sensors 22 and the signaling device 39 are all mounted at the top of the rack 10 and about the service platform 34. Both the position sensors 22 and the signaling device 39 are connected in electrical communication with the electronic computer control system 13. In this configuration, each position sensor 22 is controllably operable to sense the position of an RC vehicle 9 relative to the AECS 8 and its main service features, such as both the service hole 32 and the robotic service module 12 on the facility's service platform 34. In this way, proper alignment and controlled operation of the robotic service module 12 relative to the RC vehicle 9 is facilitated while the RC vehicle 9 is serviced on the platform 34. In this same configuration, the signaling device 39 further facilitates proper alignment between the RC vehicle 9 and both the service hole 32 and the robotic service module 12 by displaying various driving instructions to the operator of a RC vehicle, or by a transmitter 93 transmitting positional signals or commands to a remote controller 26 as dictated by the position sensors 22. Some of the driving instructions displayed on the signaling device 39 for a RC vehicle may include, for example, “go,” “slow,” “stop,” or even others.

In addition to the above, the AECS 8 also includes a transceiver 23. The transceiver 23 is mounted at the top of the rack 10 and situated along one side of the service platform 34. The transceiver 23 is also connected in electrical communication with the electronic computer control system 13. Situated and connected as such, the transceiver 23 is controllably operable to establish electromagnetic communication with a RC vehicle 9 to be serviced and thereby identify the vehicle 9 so that the robotic service module 12 can service the vehicle 9 accordingly. By initially identifying an RC vehicle 9 in this way, the electronic computer control system 13 can control the robotic service module 12 so as to install the proper type of battery 11 or the proper type of energy cell 29 into the vehicle 9.

As best illustrated in FIGS. 1 and 2, the AECS 8 further includes a control panel 24, and a display monitor 25. The control panel 24 and the display monitor 25 are mounted at the top of the rack 10 and situated along a side of the service platform 34. In addition, they are all connected in electrical communication with the electronic computer control system 13 as well. Situated and connected as such, the control panel 24 and the display monitor 25 facilitate controlled operation of the service station facility 8 by a service attendant.

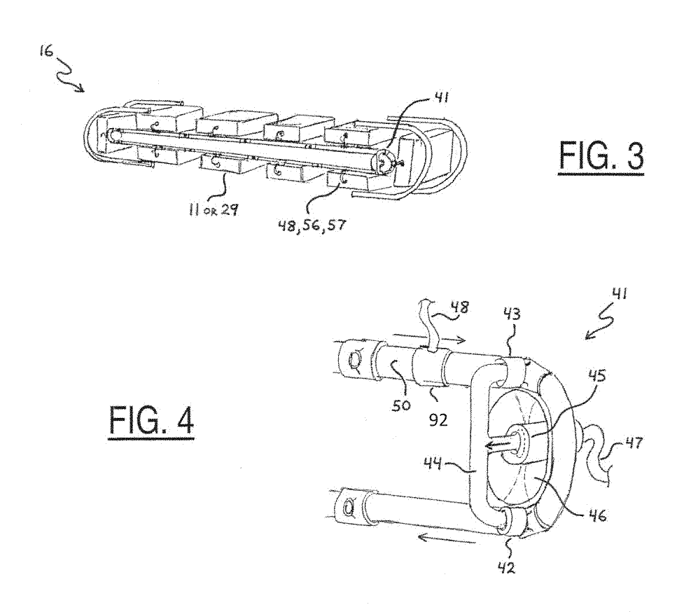

FIG. 3 illustrates a perspective view of the conveyor system 16 depicted in FIG. 2. In this view, the two rotating end shafts, the semicircular end guide rails, the holding clamps 56, and the rotating transfer manifold 41 of the conveyor system 16 are all highlighted.

FIG. 4 illustrates a perspective view of the rotating transfer manifold 41 of the conveyor system 16 depicted in FIG. 3. In this view, the dual disconnect system of the transfer manifold 41 is highlighted. As shown in FIG. 4, the dual disconnect system particularly includes one make-before-rotate quick disconnect 43 and one break-before-rotate quick disconnect 42, which are situated 180 degrees away from each other about the transfer manifold's hose wheel 46. In general, such a dual disconnect system eliminates the need for fluid hoses to circulate with the conveyor system. For multiple cooling fluid types, a series of rotating manifolds 41 can be stacked axially.

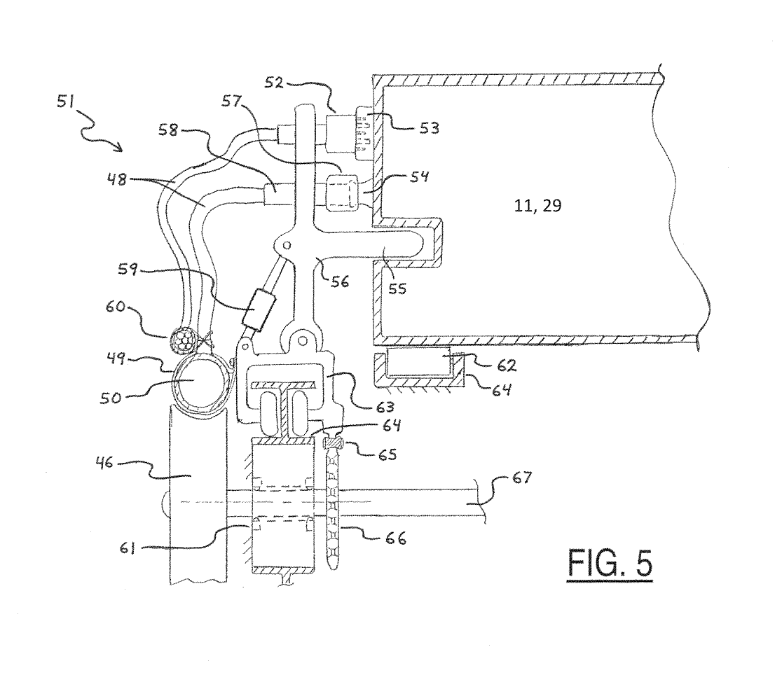

FIG. 5 illustrates a partial sectional view of one holding clamp assembly 51 of the circulating conveyor system 16 depicted in FIG. 3. In this view, the holding clamp assembly 51 is shown to ride on the railing 64 about the conveyor system 16 as driven by a pull chain 65 and a sprocket wheel 66. As further shown in the view of FIG. 5, the holding clamp 56 of the assembly 51 operates to both engage and lock onto a battery 11 or energy cell 29 on the conveyor system 16 and also pull the battery 11 or cell 29 around the conveyor system 16 so that the battery 11 or cell 29 rides on rail-mounted roller bearings 62. At about the same time that the holding clamp 56 of the assembly 51 locks onto the battery 11 or cell 29, both a fluidal connection and an electrical connection are respectively made with the battery 11 or cell 29 via an electric power connector 52 and a quick disconnect 57. To later transfer the battery 11 or cell 29 from the conveyor system 16 to the robotic service module 12 for installation onboard a RC vehicle 9, both the fluidal connection and the electrical connection established by the holding clamp assembly 51 with the battery 11 or cell 29 are broken so as to release the battery 11 or cell 29 from the conveyor system 16.

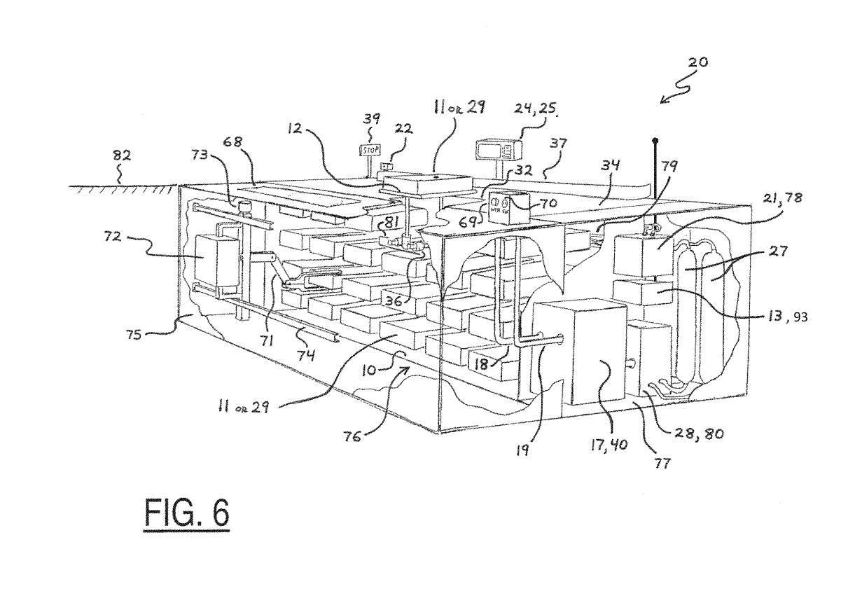

FIG. 6 illustrates a perspective view of another practicable embodiment of a AECS 20 pursuant to the present invention. In this view, the AECS 20 is shown to be largely prefabricated and housed in an enclosure 75 that has been lowered into an excavated hole in the ground. As a result, the AECS 20 has a service platform 34 that is substantially even with ground level 82.

In the embodiment depicted in FIG. 6, the AECS 20 does not include a conveyor system for moving and stocking batteries as does the facility 8 in FIGS. 1 and 2. Instead, the AECS 20 includes a bay area 76 wherein both batteries 11 and energy cells 29 are stocked and stored on a shelf-like rack 10. To move the batteries 11 and the energy cells 29 about the facility's bay area 76 and both onto and off of the robotic service module 12, the AECS 20 alternatively includes a controllable robotic arm 71 mounted on a carriage 72. The carriage 72 along with the robotic arm 71 are positionable about the facility's bay area 76 by means of a rail system 74. The carriage 72 is engaged on the rail system 74 and is moved thereon by an electric motor 73. The carriage 72 and its electric motor 73 are both connected in electrical communication with the facility's electronic computer control system 13 so as to control all movement of the robotic arm 71.

As further shown in FIG. 6, the AECS 20 also includes a plurality of supplemental storage tanks 27 and a fluid pumping system 28. The storage tanks 27 are mounted on the rack 10 and adapted to retain cooling fluids. One or more of the storage tanks 27 themselves may initially be filled for a cooling system 17 connected thereto. The fluid pumping system 28 is also mounted on the rack 10 and connected in fluidal communication with the storage tanks 27. The electronic computer control system 13 is connected in electrical communication with the fluid pumping system 28. In this configuration, cooling fluid (i.e., water for example) may generally be controllably pumped by the fluid pumping system 28 from the storage tanks 27 and into or around the replaceable batteries 11 or energy cells 29 in the bay area 76, where the fluid flow effectively absorbs and removes heat from the batteries 11 or energy cells 29. Establishing a fluidal connection between one of the storage tanks 27 and one of the replaceable batteries 11 or energy cells 29 for successfully transferring fluid therebetween for cooling the battery 11 or energy cells 29 is particularly accomplished with help from the robotic arm 71.

In addition thereto, the AECS 20 also includes an electric charging system 21. The electric charging system 21 is mounted on the rack 10 and connected in electrical communication with the electronic computer control system 13. In this configuration, electric current may generally be controllably communicated from the electric charging system 21 and into the replaceable batteries 11 or energy cells 29 in the bay area 76. Establishing an electrical connection between the electric charging system 21 and one of the replaceable batteries 11 or energy cells 29 for successfully transferring electric current therebetween for recharging the battery 29 is particularly accomplished with help from the robotic arm 71.

In a possible alternative embodiment, it is to be understood that the electric charging system 21 may be directly connected in electrical communication with the robotic service module 12 itself. In this way, the robotic service module 12 would be controllably operable to establish electrical communication with a battery-operated RC vehicle and also substantially recharge a discharged battery onboard the vehicle.

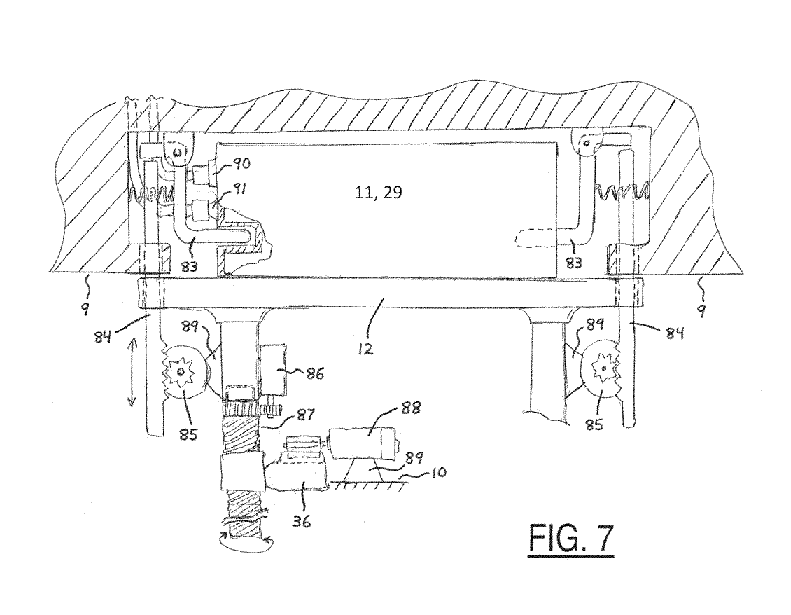

FIG. 7 illustrates a partial sectional view of the robotic service module 12 adjustably mounted on the rack 10 of the AECS 20 depicted in FIG. 6. In this view, the robotic service module 12 is engaged underneath the battery 11 or energy cell 29 of an RC vehicle 9 that is being serviced. As also shown in this view of FIG. 7, the RC vehicle 9 includes one or more retention mechanisms 83 for releasably holding the battery 11 or energy cell 29 in place after the battery 11 or energy cell 29 is installed by the robotic service module 12. As further shown in FIG. 7, the robotic service module 12 includes one or more electric torque motors 85 engaged with a matching number of vertical alignment pins 84, which ensure proper engagement of the service module 12 and the vehicle 9 while also releasing the retention mechanism 83. The jackscrew 87 and the electric motor 88 are used for moving the robotic service module 12 up and down with its battery 11 or energy cell 29 load. Equipped as such, the robotic service module 12 can thus remove a depleted battery 11 or energy cell 29 from the vehicle 9 and also install a battery 11 or energy cell 29. Furthermore, in FIG. 7, the robotic service module 12 is also shown to have both an associated rack-and-pinion mechanism 36 and an associated electric motor 88 mounted on the rack 10 of the AECS 20. Together, the rack-and-pinion mechanism 36 and the electric motor 88 work to adjust and position the robotic service module 12 for proper lateral alignment with the RC vehicle 9.

In general, the present invention as described hereinabove is able to supply both the appropriate battery 11 or energy cell 29 at needed locations in a cost effective and timely manner. It is anticipated that the invention when properly implemented will allow continuous operation of RC vehicles when needed.

In essence, the above-described Automatic Exchanging and Charging Station (AECS) 8 is a Portable Energy Rack for Inserting and Charging replaceable batteries or energy cells. The AECS can be constructed to provide conventional battery or energy cell recharging services in combination with battery or energy cell exchange capabilities.

An Automatic Exchanging and Charging Station pursuant to the present invention may be a stationary or permanent structure like the above-described facility 20. It is anticipated, however, that the portable facility 8, which can easily be moved to locations in demand of replaceable batteries or energy cells, will be highly functional and more effective in facilitating remote operations in racing or competitive locations. By using a remote controller 26 to maneuver RC vehicles to the AECS, the battery exchange or servicing process can be automatically initiated by the sensors of the AECS, or alternatively the remote controller 26 can be used to initiate the exchange or servicing process by way of a service receiver and transmitter 93. This will facilitate remote controlled operation of the AECS by a remote operator with an established communication link, RF for example, between the AECS and the remote controller 26.

The AECS 8 can be made portable through use of any suitable transportation means, including being carried in or on transportation vehicles like trucks or cars. More practically, however, the facility 8 is best made portable by means of wheels 15 attached to its undercarriage, as in a trailer. Having such wheels 15 enables the facility 8 to be easily towed, moved, pulled, and ultimately parked by most any type of transportation means, including another RC vehicle, to desired locations.

As also described hereinabove, a Stationary Automatic Exchanging and Charging Station for replaceable batteries or energy cells is proposed herein as well. This type of AECS facility 20 may be more desirable in factories or warehouses, where cargo or inventory is moved about systematically by RC vehicles. This AECS type 20 is a stationary or permanent structure, which may be prefabricated and installed or dropped into an excavated site. When utilizing such a facility 20, RC vehicles may simply be driven onto a ground-level service platform 34 to be serviced.

The AECS 8 and 20 each include a sturdy framework or rack 10 that is able to support a RC vehicle of any kind or technology or mobility, to drive onto, or be pulled or pushed by extemal means onto, the top of the AECS 8 or the service platform 34. The facilities 8 and 20 may also be constructed to provide service to RC vehicles positioned alongside each facility instead of on top each facility. In this way, the facilities 8 and 20 would each have vertical servicing capability.

The facilities 8 and 20 also incorporate within their respective structures a robotic servicing apparatus or service module 12 for exchanging batteries or energy cells in RC vehicles, automatically or autonomously. A single robotic service module 12 is generally employed to do both battery exchanges and energy cell exchanges, but two or more service modules may alternatively be installed wherein each service module is dedicated to a separate function. With removable batteries or energy cells, the robotic service module 12 will be equipped with mechanisms for first decoupling a vehicle's battery or energy cell, and then lowering it to a stowed position within the rack 10 for the purpose of recharging. Thereafter, the robotic service module 12 will reinstall a recharged battery or energy cell into the RC vehicle 9, thereby ensuring that the battery or energy cell is connected properly and secure onboard the vehicle 9. Furthermore, in the case of a vertically oriented system, the robotic service module 12 may automatically replace or replenish a desired energy source.

The AECS 8 and 20 are constnructed and designed to move their respective robotic service modules 12 to specific locations on a serviced RC vehicle 9 where the vehicle 9 needs to be serviced. Alternatively or in combination therewith, the facilities 8 and 20 may also be constructed with means to position each vehicle 9 in a specific orientation on the rack 10 or service platform 34 for proper alignment, so as to service the vehicle 9 with a battery or energy cell of any type as required by the vehicle 9. For example, in some constructed facility configurations, vehicles may be pulled up alongside the facilities 8 and 20. Thereafter, the battery exchange or recharging may be carried out in an automated manner.

The battery or energy cell cooling capability is accomplished by providing onboard storage tanks 27, transfer lines, electric cables, pumps, battery chargers and also cable hook-ups. The storage tanks 27 may be refilled by onboard generators for the cooling systems 17. In addition thereto or alternatively, they may also be refilled via one or more external sources such as, for example, a tanker truck, manually, or even one or more stationary pipelines.

Primarily, or in combination, the AECS 8 and 20 are constructed to service vehicles with removable energy storage devices such as batteries. The facilities 8 and 20 will contain within their respective mid sections a store of appropriate batteries or energy cells that are completely or substantially charged, and will replace or exchange a vehicle's removed battery or energy cell with a pre-replenished one. Alternatively, the facilities 8 and 20 may be interfaced with an adjacent store or silo of batteries or energy cells for the exchange. In general, the exchange method implemented in these facilities 8 and 20 is highly efficient in that no recharge time is required for the RC vehicles themselves, which can take several minutes to hours. That is, in facilities 8 and 20, a user may simply drive his vehicle 9 onto or alongside the service platform 34 of the facility, wait a few seconds for the exchange to take place, and then simply drive away. Such a brief and timely exchange is one of the most desirable aspects of both the AECS 8 and 20.

An example structure for the AECS 8 is a rectangular framework or rack 10 that is constructed with a truss to support RC vehicles 9 parked on top, to hold replaceable batteries or energy cells stored in recharging bays, or to hold a rotating conveyer system 16 of cells. A rail system 81 for moving each of the robotic service modules 12, or a rail system 74 for moving the robotic arm 71 are each mounted to the respective framework or rack 10 of the facilities 8 and 20. Each framework or rack 10 also includes compartments 77 for storage tanks 27, generators or cooling systems 17, heating and cooling units, and electronic computer control systems 13. Twin axial wheels 15 and stabilizers 35 are mounted to the undercarriage of the AECS 8, along with a tow bar 14 mounted to the front, to thereby form a mobile trailer.

An example structure for the AECS 20 is similar to the AECS 8, except that the mobility aspect is not present in the AECS 20. Instead, the AECS 20 is constructed to be modular so that it can easily be placed on or into the ground using at a desired destination site. The AECS 20 is substantially enclosed with, for example, fiberglass walls for thereby withstanding any adverse effects from the elements of ground or in-ground environments.

An electronic computer control system 13 is mounted within each facility's controls for thereby exchanging energy cells or batteries within vehicles. Mounted as such, the electronic computer control system 13 operates to control and monitor the recharging of spent cells or batteries, and also controls any communication links established between the facility itself, the RC vehicles 9, and the control panel 24. The electronic computer control system 13 is loaded with autonomous software for the automatic or autonomous control of the overall facility. Such control may particularly include, for example, the positioning of the robotic service module 12 for proper vehicle alignment, the monitoring and moving of the batteries or energy cells to and from the vehicles, the assuring of proper connections of cooling hoses and electric cables for safe operation, and also the monitoring and controlling of communication interfaces between the facility itself, the vehicles 9, and the service control panels 24.

The electronic computer control system 13 interfaces with the facility's proximity or position sensors 22 for thereby determining the relative locations of vehicles 9, and the computer control system 13 also calculates the required repositioning for proper alignment. Such location information is also used to communicate directions to a user through the control panel's associated display monitor 25 and electronic signaling device 39 mounted on the service station facility. The direction commands given by the signaling device 39 may instruct a vehicle driver to, for example, pull forward and stop as necessary for a proper exchange to take place.

In addition to the above, AECS has means for interacting with and sensing the type of vehicles, to determining the battery or energy cell type requirement along with the quantity of charge to be replenished, or the battery or energy cell type and state of charge. The interaction protocol and identification code definitions may be developed by collaboration with industry. The vehicle codes can be attached to the vehicles in an established location in the form of magnetic strips or barcodes for reading by one or more sensors or transceivers 23 mounted on the facility. However, this type of link is limited in that no variable information can be transmitted from the vehicles to the facility about type or charge levels. A better alternative is for the facility and vehicles to have a communication link by means of infrared transceivers, electrical signal contacts, or wireless Radio Frequency Identification (RFID) means. These types of communication links can transmit the vehicle type, along with battery or energy cell type and charge level. The transmitted vehicle information is then communicated to the facility's electronic computer control system 13. The computer control system 13 may then control any actions necessary for properly servicing the vehicle.

If recharging, the level of recharge can be controlled by the vehicle operator himself, or by a service attendant, via the control panel 24 mounted on the facility, with the control panel 24 more preferably made accessible to the driver by remote control means 26. In an alternative embodiment, a second control panel may be mounted on the side of the rack 10 for access by an operator. Such an additional control panel may also be remotely operated via a cable or a wireless connection to the facility by a service attendant.

After the AECS 8 has determined the vehicle battery or energy cell requirements, the facility 8 will automatically move the robotic service module 12 to the exchange location on the vehicle, and autonomously exchange the battery or energy cell. The exchange process is performed by removing the spent battery or cell from the vehicle, and then placing it onto the conveyor system 16. A fresh battery or cell is then rotated by the conveyor system 16 to the insertion position. In contrast, in the AECS 20, the robotic arm 71 may move the battery or cell to the bay area 76 for recharging, and the arm 71 may also retrieve a fresh unit for replacement and installation in the vehicle. In collaboration with industry, a standard retention mechanism 83, for example, may be defined for various types of batteries or energy cells so as to hold the batteries or cells in the undercarriage of their respective vehicles. The robotic service module 12 will achieve alignment with the vehicle retention mechanism 83 by means of the position sensors 22. The robotic service module 12 then engages the retention mechanism 83 via alignment pins 84, and then actively causes the retention mechanism 83 to release the battery 11 or cell 29 from the vehicle 9. This can be accomplished, for example, by rotating a screw type locking bolt of the retention mechanism 83 by using an electric torque motor 85. The robotic service module 12 is maneuvered within the facility 20 also by electric motors on the rail system 81 via wheels or bearings. Alternatively, the robotic service module 12 may be positioned by a rack-and-pinion mechanism 36. Also, the robotic service module may lift and lower batteries or cells using another electric motor and a jackscrew lift, or alternatively a hydraulic jack lift system 31. The robotic arm 71 along with its carriage 72 may maneuver in a similar manner, except that the robotic arm 71 itself will perform the lowering, lifting, and placing of the batteries or cells into the bay area 76 for charging. The robotic arm 71 may be somewhat more versatile in that the interface definition of the individual batteries or energy cells can be somewhat varied and less narrowly defined. That is, given the robotic arm's dexterous clamp or claw on its distal end and also its intelligent controlling software, the robotic arm 71 may be utilized to grasp and move batteries and energy cells having multiple different configurations.

Alternatively or in combination with each robotic service module 12, the service AECS facilities 8 and 20 may be constructed with a movable service platform to help position the vehicles in a specific orientation for proper alignment. Such can be accomplished, for example, by using hydraulic cylinders or electric motors connected to a floating service platform on bearings. The cylinders would extend or retract as directed by the electronic computer control system 13. In such an embodiment, the computer control system 13 sends position commands to cylinder valve controllers and receives position feedback signals from position sensors on the service platform. A simpler method, however, would be to use a guide rail 37 mounted to the service platform 34. Such will force the vehicle driver to place the vehicle in an approximate initial alignment position. Thereafter, final alignment may easily be achieved via the mobility of the robotic service module 12 itself.

If a cooling process is required during periods of recharging, the robotic service module 12 will autonomously connect a cooling hose or appendage as required to the vehicle. This again, can be accomplished by defining interface requirements with industry, and having the service module 12 maneuver the hose with gears, levers, screws, and sensors in a predefined manner for positive engagement. A robotic arm with intelligent software, however, may again be a better approach for thereby ensuring versatile engagement capability.

Preferably, the vehicle charging port would be located on the undercarriage of the vehicle, for ease of the mating process, but such is not a necessary restriction. For side-mounted charging ports on vehicles, the AECS 8 will have side-mounted robotic service modules for vehicles to park alongside. For vehicles pulled on top of the AECS 8 and 20, top-protruding side service modules 12 will be utilized. In general, side-charging robotic service modules will operate and maneuver in a similar manner as the undercarriage-charging service modules 12.

One method of stowing and recharging the batteries or energy cells is for the facility to contain within its midsection, a conveyor system 16 to move the removed batteries or cells around a closed loop while being recharged. In this manner, the removed units are rotated out of the way, while the replenished units are simultaneously rotated into position for installation by the robotic service module 12. The length of the conveyor system 16, and consequently the number of stowed units, can be adjusted to meet the supply demand in concert with the recharging timing requirements.

In general, the conveyor system 16 includes a chain with holding clamps that automatically grasp the battery or energy cell when put in place by the robotic service module 12. Also mounted to the chain and split off to the clamps, are fluid umbilical hoses and/or electric cables 48 for cooling and recharging. The clamps are spaced on the chain with a spacing to accommodate the predefined battery or cell sizes. The clamp devices incorporate sensors to sense when a battery or cell is placed, triggering a clamping action. The clamping action is electromagnetically driven, but could be actuated by pneumatic means as well. The clamps also contain alignment sensors and quick disconnects for aligning and connecting the umbilical hose or cables 48. The umbilical devices will contain quick disconnects, connectors, or brushes as needed to temporarily connect the batteries or cells as they are placed and removed from the conveyor system 16 by the robotic service module 12. The clamps also contain electromagnetic actuators and sensors for aligning and establishing these temporary connections, which occurs after the clamping device confirms a positive battery or cell clamp.

The conveyor system 16 itself is rotated by an electric step motor, but can also be rotated by a hydraulic or pneumatic motor as well. Operation of the conveyor system motor is controlled by commands given by the electronic computer control system 13. The required cooling fluid and charge is transferred from storage tanks and generators to the conveyor cooling and recharging hoses and cables, by a slip ring 45 mounted to a conveyor hose wheel 46 at one end of the conveyor system 16. Alternatively, the fluid and/or charge transfers can be done by a dual quick disconnect manifold with sensors and actuators similar in operation to the umbilical arrangement. During a rotational step of the conveyor system 16, one quick disconnect is maintained while the other is released. This method eliminates the need for a service transfer hose and cable that would need to circulate around with the conveyor system 16.

Another method of cooling and recharging the exchangeable batteries and energy cells is for the facility to contain a storage rack system (or bay area) either internally within or adjacent to the facility. The robotic service module 12 or robotic arm 71 would be controlled by electrical control signals communicated from the electronic computer control system 13, and would maneuver on rail systems as previously described herein. The computer control system 13 would receive charge level signals and types from sensors situated within the bay areas. Keeping track of charge levels enables the computer control system 13 to select a battery or cell that meats a charge or type requirement of the user. Such a system is more flexible in allowing the user to select batteries or cells. In using a conveyor system, if a user wanted to select a particular type battery or charge, the unit conveyor could be rotated to position a more recently removed battery or cell partially charged, or preferentially desired type, for installation.

In general, there are two ways in which an AECS can obtain required battery or energy cell charges. They can be externally generated and transferred to energy storage cells or batteries within the facilities for instantaneous servicing of the vehicles, or for later transfer to the vehicle batteries and energy cells. Alternatively or in combination, the facilities contain on-board charge generators and electrical converters, or battery chargers, for charging batteries or energy cells contained within the unit.

Currently, there are many off-the-shelf battery chargers and generators commercially available. Any quantity or combination of such devices may optionally be included within either of the AECS 8 and 20 to generate or convert the charges needed or required to service vehicle demand.

In summary, the AECS 8 and 20 generally act as universal power generators, electric converters, and energy storage facilities, and also generally provide a universal interface for various RC vehicle electric charge needs. The AECS 8 and 20 are generally equipped with universal adapters as needed to output charges using connectors for interfacing with RC vehicles. Additionally, the ASSF 8 and 20 also perform an autonomous or automatic exchange of batteries and energy cells of any type, thereby simplifying, expediting, and making easier the energy input or transfer to RC vehicles. The structure and function of the AECS 8 and 20 are to provide an energy delivery system that interfaces universally with these inputs, outputs, and also meets user needs. Such is why the AECS proposed herein are so useful. In particular, simply replacing a battery with a fully re-charged one generally eliminates any significant time period for waiting while a vehicle is serviced. That is, if the vehicles are properly constructed with replaceable batteries or energy cells, and the machinery for performing the exchange is sufficiently robust, then such swapping can be accomplished with any type of battery or energy cell in a matter of seconds.

While the present invention has been described in what are presently considered to be its most practical and preferred embodiments or implementations, it is to be understood that the invention is not to be limited to the particular embodiments disclosed hereinabove. On the contrary, the present invention is intended to cover various modifications and equivalent arrangements included within the spirit and scope of the claims appended hereinbelow, which scope is to be accorded the broadest interpretation so as to encompass all such modifications and equivalent structures as are permitted under the law.

1. An automatic exchanging and charging station for replenishing electric energy sources onboard different types of RC hobby vehicles, said facility comprising:
a rack;
a plurality of replaceable batteries stocked on said rack and substantially charged as motivational energy sources within electric powered RC hobby vehicles;
a service module mounted on said rack; and
an electronic computer control system connected in electrical communication with said service module;
wherein said service module is controllably operable to receive a depleted replaceable battery from a electric powered RC hobby vehicle and also selectively deliver one of said charged replaceable batteries onboard said electric powered RC hobby vehicle.

2. An automatic exchanging and charging station according to claim 1, wherein said service station facility further comprises:
a hitch mounted on said rack; and
a plurality of wheels rotatably mounted at the bottom of said rack;
wherein both said hitch and said wheels facilitate towing of said facility.

3. An automatic exchanging and charging station according to claim 1, wherein said service station facility further comprises:
a conveyor system mounted on said rack and connected in electrical communication with said electronic computer control system;
wherein said conveyor system is controllably operable to circulate said replaceable batteries about said service station facility so that said service module has selective access to each of said replaceable batteries.

4. An automatic exchanging and charging station according to claim 1, wherein said service station facility further comprises:
a cooling system connected in electrical communication with said electronic computer control system and controllably connectable in fluidal communication with any of said replaceable batteries;
wherein said cooling system is controllably operable to receive both cooling fluids and electricity to thereby cool while substantially charging any of said replaceable batteries.

5. An automatic exchanging and charging station according to claim 1, wherein said service station facility further comprises:
a plurality of replaceable batteries stocked on said rack and substantially charged with electric charges utile as motivational energy sources within battery-operated RC hobby vehicles;
wherein said service module is controllably operable to receive a discharged replaceable battery from a battery-operated RC hobby vehicle and also selectively deliver one of said charged replaceable batteries onboard said battery-operated a RC hobby vehicle.

6. An automatic exchanging and charging station according to claim 5, wherein said replaceable batteries stocked on said rack may include at least one battery selected from the group consisting of a lead-acid type battery, a lithium-ion type battery, a nickel-cadmium type battery, a nickel/metal-hydride type battery, and a silver-zinc type battery, or any type of battery in general.

7. An automatic exchanging and charging station according to claim 5, wherein said service station facility further comprises:
a conveyor system mounted on said rack and connected in electrical communication with said electronic computer control system;
wherein said conveyor system is controllably operable to circulate said replaceable batteries about said service station facility so that said service module has selective access to each of said replaceable batteries.

8. An automatic exchanging and charging station according to claim 5, wherein said service station facility further comprises:
an electric charging system connected in electrical communication with said electronic computer control system and controllably connectable in electrical communication with any of said replaceable batteries that are designated for charging;
wherein said electric charging system is controllably operable to substantially charge any of said replaceable batteries designated for charging.

9. An automatic exchanging and charging station according to claim 1, wherein said service station facility further comprises:
at least one position sensor mounted on said rack and connected in electrical communication with said electronic computer control system;
wherein each said position sensor is controllably operable to sense the position of an RC hobby vehicle relative to said service station facility so as to facilitate alignment and controlled operation of said service module relative to said RC hobby vehicle while said RC hobby vehicle is serviced.

10. An automatic exchanging and charging station according to claim 1, wherein said service station facility further comprises:
a transceiver mounted on said rack and connected in electrical communication with said electronic computer control system;
wherein said transceiver is controllably operable to establish communication with an RC hobby vehicle and thereby identify said RC hobby vehicle so as to accordingly service said RC hobby vehicle with said service module.

11. An automatic exchanging and charging station according to claim 1, wherein said service station facility further comprises:
a service receiver or control panel connected in electrical communication with said electronic computer control system;
a service transmitter or display monitor connected in electrical communication with said electronic computer control system;
wherein both said service receiver/control panel and said service transmitter/display monitor facilitate controlled operation of said automatic exchanging and charging station by a remote operator with an established communication link between the automatic exchanging and charging station and a remote control device, or local controlled operation by a service attendant.

12. An automatic exchanging and charging station for replenishing energy sources onboard different types of RC hobby vehicles, said service station facility comprising:
a rack;
a plurality of enemy cells mounted on said rack and adapted to retain electrical energy as motivational energy sources within electric-powered RC hobby vehicles;
a charging system mounted on said rack and connected in electrical communication with said energy cells;
a service module mounted on said rack and connected in electrical communication with said energy cells; and
an electronic computer control system connected in electrical communication with said charging system and said service module;
wherein said service module is controllably operable to receive a discharged replaceable battery from a battery-powered RC hobby vehicle and also selectively deliver one of said charged replaceable batteries onboard said battery-powered a RC hobby vehicle;
wherein said service module is also controllably operable to establish electrical communication with an electric-powered RC hobby vehicle and also selectively deliver electric power into a depleted energy cell onboard said electric-powered RC hobby vehicle.

13. An automatic exchanging and charging station according to claim 12, wherein said service station facility further comprises:
a cooling system connected in electrical communication with said electronic computer control system and connected in fluidal communication with any of said storage tanks that are designated for retaining cooling fluids;
wherein said cooling system is controllably operable to receive both cooling fluids and electricity to thereby cool an energy cell while substantially charging said energy cell.

14. An automatic exchanging and charging station according to claim 12, wherein said service station facility further comprises:
an electric charging system connected in electrical communication with both said electronic computer control system and said service module;
wherein said service module is controllably operable to establish electrical communication with a battery-operated RC hobby vehicle and also substantially charge a discharged battery onboard said battery-operated RC hobby vehicle.

15. An automatic exchanging and charging station according to claim 12, wherein said service station facility further comprises:
a service receiver or control panel connected in electrical communication with said electronic computer control system;
a service transmitter or display monitor connected in electrical communication with said electronic computer control system;
wherein both said service receiver/control panel and said service transmitter/display monitor facilitate controlled operation of said automatic exchanging and charging station by a remote operator with an established communication link between the automatic exchanging and charging station and a remote control device, or local controlled operation by a service attendant.

16. An automatic exchanging and charging station according to claim 15, wherein said service station facility further comprises:
a plurality of replaceable batteries stocked on said rack and substantially charged with electric charges utile as motivational energy sources within battery-operated RC hobby vehicles;
an electric charging system connected in electrical communication with both said electronic computer control system and said service module and controllably connectable in electrical communication with any of said replaceable batteries that are designated for charging;
wherein said service module is controllably operable to receive a discharged replaceable battery from a battery-operated RC hobby vehicle and also selectively deliver one of said charged replaceable batteries onboard said battery-operated RC hobby vehicle;
wherein said electric charging system is controllably operable to substantially charge any of said replaceable batteries designated for charging; and
wherein said service module is controllably operable to establish electrical communication with a battery-operated RC hobby vehicle and also substantially charge a discharged battery onboard said battery-operated RC hobby vehicle.
